(19) United States
(12) Patent Application Publication
(10) Pub. No.: US 2010/0172683 A1
(43) Pub. Date: Jul. 8, 2010

(54) Trip Recorder

(75) Inventor: Torsten Wahler, Bad Dürrheim (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/602,307

(22) PCT Filed: Apr. 28, 2008
(86) PCT No.: PCT/EP08/55137

§ 371 Date: Nov. 30, 2009

(30) Foreign Application Priority Data
May 29, 2007 (DE) 10 2007 025 169.8

(51) Int. Cl. B41J 33/14

(52) U.S. Cl. 400/223

(57) ABSTRACT

A trip recorder having an open or openable housing, in which a printing device comprising a thermoprinting strip and a receptacle for a roll, rotatable about an axis of rotation, of a ribbon-like print material printable by the printing device are disposed. The thermoprinting strip is parallel to and opposite a transport roller rotatably drivable about a roller axis, by which the print material fed past the thermoprinting strip can be applied against the thermoprinting strip. The region of the receptacle of the printable print material is accessible from the outside. The housing has an opening facing an operator side. The thermoprinting strip is disposed in a stationary manner in the housing and the transport roller can be lifted away from the thermoprinting strip. The axis of rotation of the roll of printable print material and the transport roller are directed toward the operator side.

### PRIORITY CLAIM

This is a U.S. national stage of application No. PCT/EP2008/055137, filed on Apr. 28, 2008, which claims Priority to the German, Application No.: 10 2007 025 169.8, filed: May 29, 2007; the content of both incorporated herein by reference.

### BACKGROUND OF THE INVENTION

1. Field of the Invention

The invention relates to a trip recorder having an open or openable housing, in which a printing device comprising a thermoprinting strip and a receptacle for a roll, rotatable about an axis of rotation, of a ribbon-like printing material that can be printed on by the printing device are arranged. The printing device has a transport roller which is located parallel to and opposite the thermoprinting strip and can be driven rotatably about a roller axis by which the printing material, which can be conveyed past the thermoprinting strip, can be applied to the thermoprinting strip, wherein the region of the receptacle of the printing material that can be printed on can be accessed from the outside.

2. Prior Art

In such trip recorders, referred to as digital tachographs, both driver-related and vehicle-related data are printed onto a strip-like printing material that can be printed on. Memory chips are arranged on a chip card for storage and archiving of the data.

It is known to introduce the strip-like printing material as a roll into a drawer that can be pushed out, wherein, when the drawer is pushed in, a small end piece of the printing material peeks out from a slot in the device. When a printout is made, the printed printing material moves out of the slot in an outward direction.

The interior of the device is always connected to the outside through the slot, with the result that dust and moisture can easily penetrate into the device.

The drawer requires complex rail guides and a mechanism for opening the drawer.

The printing device requires a complex design with a spring bearing of the thermoprinting strip for tolerance compensation. Furthermore, the transport roller with its drive must also be arranged in the drawer, which requires flexible electrical connections, which are susceptible to defects, to a printed circuit board on which the system electronics of the trip recorder are mounted.

### SUMMARY OF THE INVENTION

An object of the invention is to provide a trip recorder that avoids these disadvantages, permits easy equipment with a roll of the printing material, and is simple in design.

This object is achieved according to one embodiment of the invention in that the housing has an opening directed toward an operator side, the thermoprinting strip is arranged fixed in the housing, and the transport roller can be lifted off from the thermoprinting strip, and the axis of rotation of the roll of the printing material and the transport roller are directed toward the operator side.

This design does not require any flexible electrical lines leading to the thermoprinting strip.

The arrangement of the axis of rotation of the roll of the printing material is directed toward the operator side, with the result that re-equipment with such a roll is possible, without the need for a drawer to be pulled out and pushed in.

The housing can have a printing material chamber, which is arranged on the insertion side of the thermoprinting strip and transport roller as a receptacle for the roll of printing material.

In this context, fixed positioning and low-friction rotatability of the roll are achieved by virtue of the fact that a printing material dome, which projects freely toward the operator side and on which a roll of printing material can be arranged in a freely rotatable fashion, is arranged in the printing material chamber.

If the housing has a printed material chamber on the discharge side of the thermoprinting strip and transport roller, the printed printing material is held there until its removal and does not hang as a strip of printing material into the passenger compartment of the motor vehicle.

If the printed material chamber has a round cross section, and in particular a circular cross section, into which a feed-in slot opens, said feed-in slot leading from the support region of the transport roller on the thermoprinting strip to the printed material chamber, the printed printing material is forcibly rolled up after the printing process and therefore requires only a small amount of space.

In this context, the impact process is particularly favorable if the feed-in slot opens at least approximately tangentially into the round printed material chamber.

To protect against soiling and moisture, the opening of the housing can be closed off by a closure.

In this context, easy handlability for opening and closing is obtained if the closure is a closure door which is mounted so as to be pivotable about a door axis which extends along an edge of a rectangular or square opening.

To be able to insert the free end of the printing material easily between the transport roller and the thermoprinting strip from the operator side when the trip recorder is being re-equipped with printing material, the transport roller can be rotatably mounted on a carrier which can be driven in such a way that it can be moved toward the thermoprinting strip and away from the thermoprinting strip.

If the carrier here is spring-loaded onto the thermoprinting strip, the transport roller applies the printing material uniformly over its entire length with a specific force against the thermoprinting strip.

For this purpose, the carrier can easily be movably guided in a guide shaft of the housing and/or on fixed guide elements.

If the carrier here has a drive device for rotatably driving the transport roller, simple rotational transmission can occur from the rotary drive to the transport roller.

To drive the movement of the carrier and the transport roller, the carrier can be capable of being driven such that it can be moved toward the thermoprinting strip and away from the thermoprinting strip by an adjustment device which can be activated manually.

Automatic lifting of the transport roller occurs when the closure door opens, and automatic lowering occurs when the closure door closes, if the adjustment device is coupled to the closure door, wherein the closing movement of the closure door can generate a movement of the carrier toward the thermoprinting strip, and an opening movement of the closure door can generate a movement of the carrier away from the thermoprinting strip.

In one embodiment of the invention, an adjustment slide which can be driven such that it can be moved in the direction of the operator side can be movably guided on the housing, said adjustment slide being coupled to the closure door by a coupling and being coupled to the carrier by a cam drive. The coupling is preferably coupled by its one end directed toward the operator side with radial spacing with respect to the door axis, and more preferably it is coupled by its second end, directed toward the adjustment slide, to the end, directed toward the operator side, of the adjustment slide.

To transmit the movement of the adjustment slide to the carrier, the adjustment slide can have a link path which extends in the longitudinal extent of the adjustment slide from an end which is relatively close to the carrier to an end which is more remote from the carrier, and into which link path a link block of the carrier engages.

If a plurality of link paths are arranged one behind the other in the adjustment slide in the direction of the longitudinal extent of the adjustment slide, and a link block of the carrier engages in each of said link paths, this transmission of movement is carried out particularly uniformly and in a way which is protected against tilting.

To keep the carrier stable in the end positions of its movement stroke, the end, which is relatively close to the carrier, of the link path and/or the end, which is more remote from the carrier, of the link path can extend in parallel to the roller axis.

The adjustment slide is guided in such a way that it can be slid without additional components if the adjustment slide is guided displaceably in a guide slot in a wall of the housing, wherein the adjustment slide has, in a preferable and in particularly simple and reliably guiding fashion, guide grooves on sides which are located opposite one another, wherein the web which is formed between the bases of the guide grooves can be inserted into the guide slot.

If the thermoprinting strip is arranged on a printed circuit board on all or part of which the system electronics of the trip recorder are mounted, there is no need for any flexible electrical connections, which are susceptible to faults, between the system electronics and the thermoprinting strip.

In this context, easy mountability is obtained if the thermoprinting strip projects through a cutout in a wall of the housing, wherein the printed circuit board is arranged on the outside of the wall of the housing.

### BRIEF DESCRIPTION OF DRAWINGS

An exemplary embodiment of the invention is illustrated in the drawings and will be explained in more detail below. In said drawings:

FIG. 1 is a perspective front view of a trip recorder;

FIG. 2 is a cross section through the trip recorder according to figure I in the region of a carrier when the closure door is closed;

FIG. 3 is the view of the trip recorder from FIG. 2 when the closure door is half open;

FIG. 4 is the view of the trip recorder from FIG. 2 when the closure door is completely open,

FIG. 5 is a perspective exploded illustration of the trip recorder according to FIG. 1;

FIG. 6 is a perspective front view of the housing of the trip recorder according to FIG. 1;

FIG. 7 is a plan view of the housing of the trip recorder according to FIG. 1;

FIG. 8 is a section along the line VII-VII in FIG. 7;

FIG. 9 is a perspective view of a detail of a printed circuit board of the trip recorder according to FIG. 1;

FIG. 10 is a plan view of the detail of the printed circuit board in FIG. 9;

FIG. 11 is a side view of the detail of the printed circuit board in FIG. 9;

FIG. 12 is a perspective view of an adjustment slide of the trip recorder according to FIG. 1;

FIG. 13 is a perspective view of the carrier, provided with a transport roller, of the trip recorder according to FIG. 1;

FIG. 14 is a cross section through the carrier, provided with the transport roller, according to FIG. 13;

FIG. 15 is a perspective view of a module composed of a carrier, transport roller and adjustment slide;

FIG. 16 is a front view of the module according to FIG. 15

FIG. 17 is a section along the line XVI-XVI from FIG. 16

FIG. 18 is a view of the module according to FIG. 15 from below; and

FIG. 19 is a front view of the housing of the trip recorder according to FIG. 1.

### DETAILED DESCRIPTION OF THE DRAWINGS

The trip recorder illustrated in the figures has a housing 1 with a rectangular cross section in the DIN radio format.

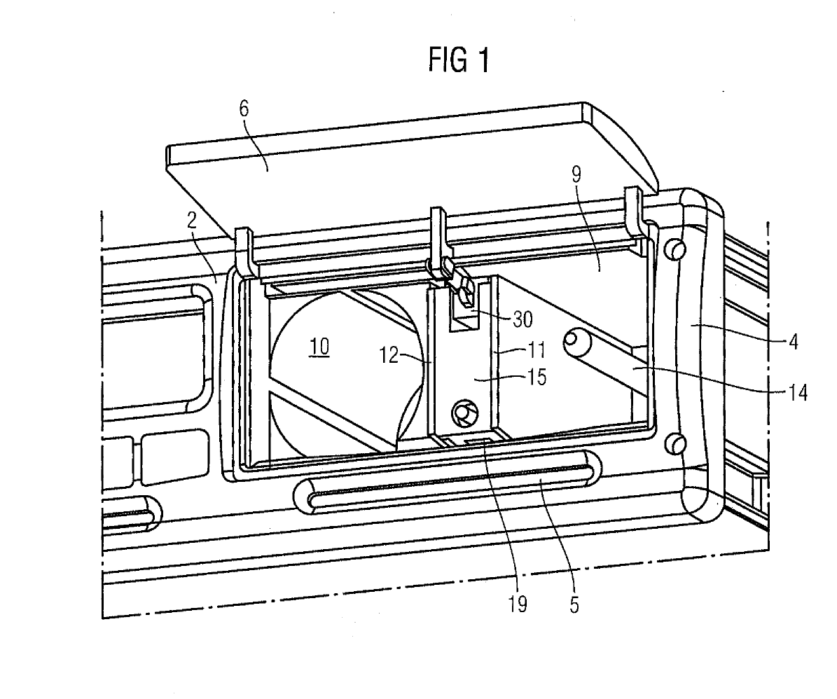

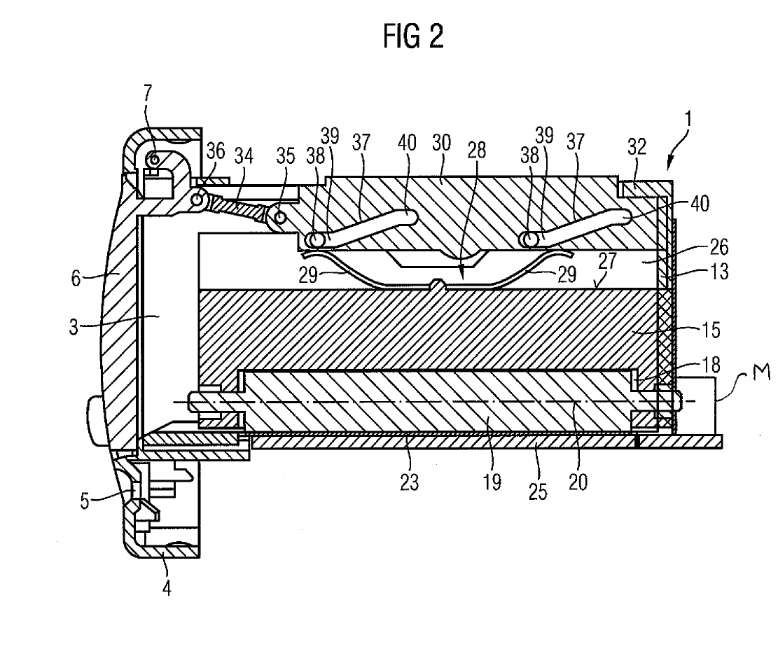

As is shown in FIGS. 1 and 2, the housing 1 can be inserted into a corresponding shaft in the dashboard 2 of a motor vehicle and be covered by a face panel frame 4 on its opening 3 directed toward an operator side.

An insertion slot 5 into which a chip card can be inserted which contains memory chips for storing data such as driver data, vehicle data, travel data and working time data, is formed under the underside of the opening 3, in the face panel frame 4.

The opening 3 can be closed off by a closure door 6, which is mounted so as to be pivotable about a door axis 7 that extends horizontally along the upper edge region of the opening.

A guide shaft 8 divides the interior of the housing 1 into a right-hand printing material chamber 9 and a left-hand printed material chamber 10. A guide shaft 8 is arranged centrally and perpendicularly in the interior (see, e.g., FIG. 5).

In this context, two dividing walls 11 and 12, which are arranged at a distance from one another, form the guide shaft 8.

On the side facing away from the operator side, a housing floor 13 closes off the housing 1. A mandrel-like printing material dome or post 14 is arranged on the housing floor 13, which printing material post 14 projects freely toward the operator side, and approximately centrally into the printing material chamber 9.

A roll (not illustrated) of printing material is arranged by its tube-like central opening, such that it can be freely rotated, on the printing material post 14.

The printed material chamber 10 has a circular cross section as viewed from the operator side.

A carrier 15 is guided in a vertically slidable fashion between the dividing walls 11 and 12 of the guide shaft 8.

Vertical guidance for carrier 15 is assisted by guide protrusions which extend perpendicularly at a distance from one another on the dividing wall 11 and which protrude from the guide-shaft-side plane of the dividing wall 11 and project into corresponding guide grooves 17 of the carrier 15 (see FIG. 5).

In a transport roller chamber 18, which is formed on the lower region of the carrier 15, a transport roller 19 is mounted so as to be rotatable about a roller axis 20 which is directed toward the operator side, parallel to the printing material post 14.

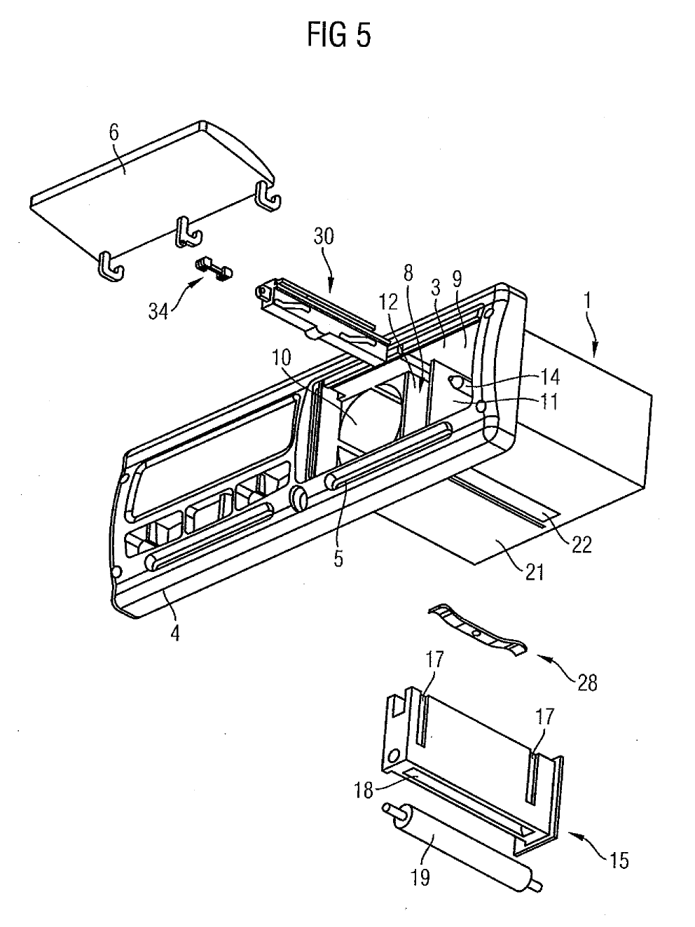

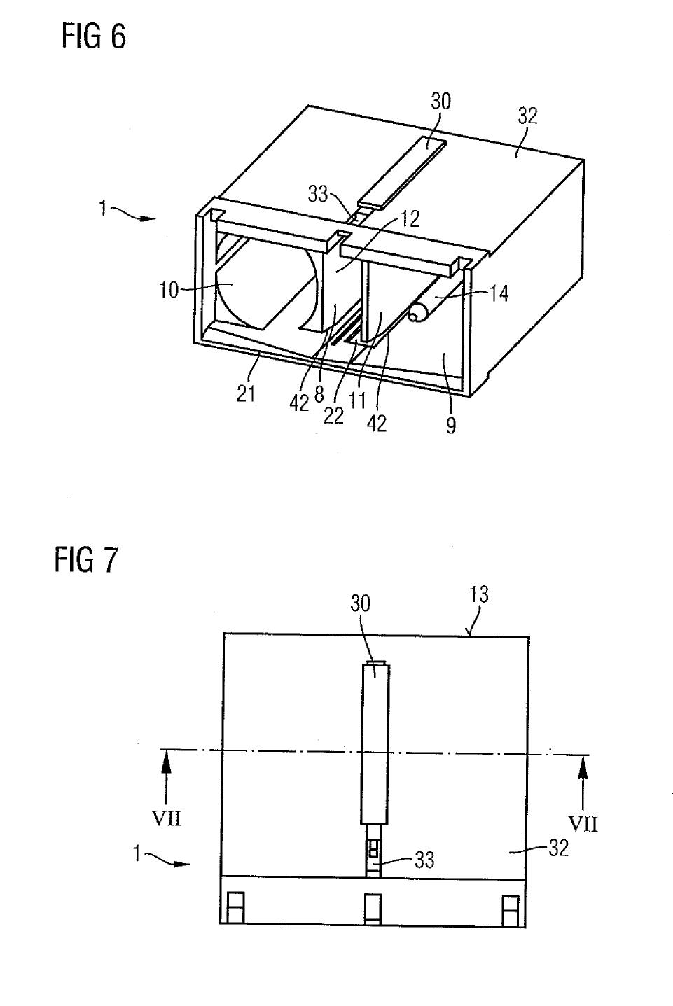

A continuous cutout 22 (see, e.g., FIG. 6), which has a rectangular cross section and extends largely over the housing depth and through which a printing strip carrier 23 projects, is formed in the region of the guide shaft 8, in the lower wall 21 of the housing 1.

A thermoprinting strip 24 (see, e.g., FIG. 9) is arranged on the guide shaft side, opposite the transport roller 19 on the printing strip carrier 23.

The printing strip carrier 23 is attached, by its side opposite the thermoprinting strip 24, to a printed circuit board 25 which is in turn arranged on the outside of the lower wall 21 and on which the system electronics 100, shown schematically, of the trip recorder are mounted (see FIG. 9).

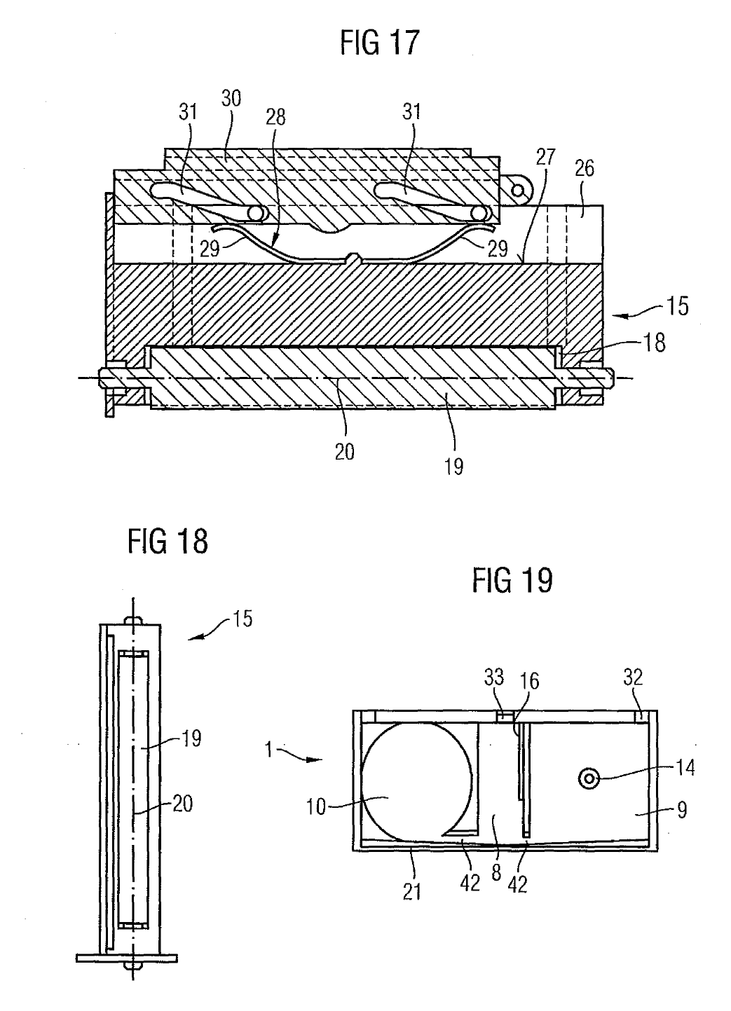

The end region, opposite the transport roller chamber 18, of the carrier 15 is embodied as an upwardly open carrier chamber 26, to the floor 27 of which a two-armed leaf spring 28 is attached by its central region (see FIG. 17).

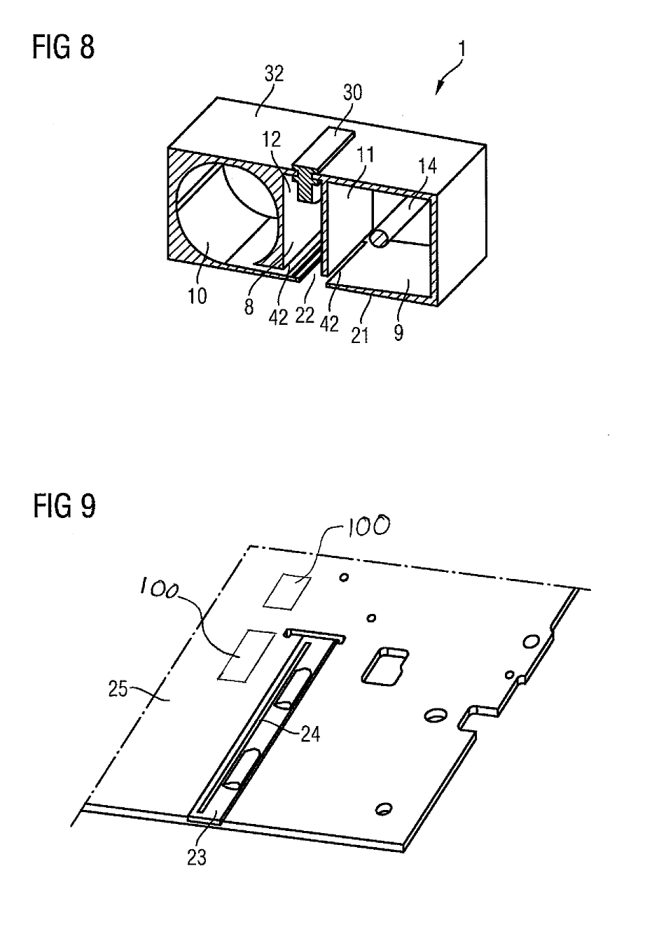

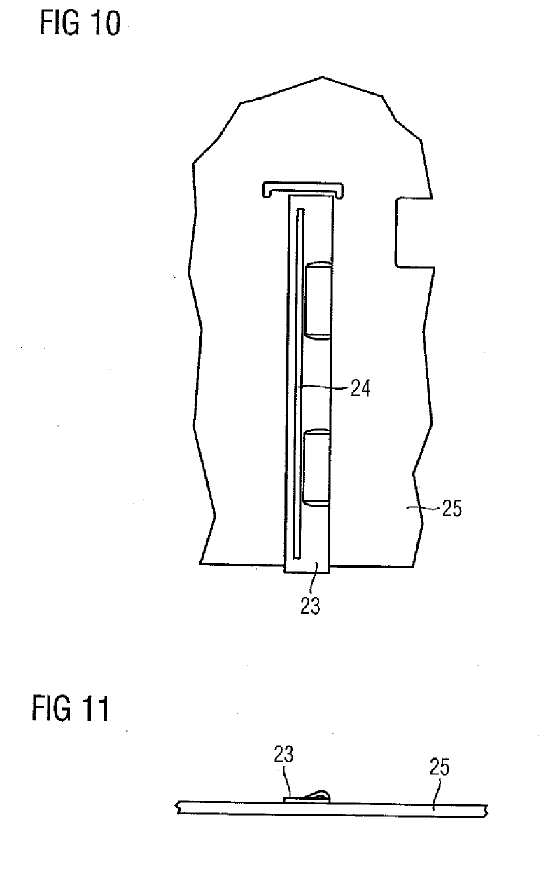

The spring arms 29 of the leaf spring 28 are inclined upward and bear with their free ends on the underside of an adjustment slide 30, with the result that the slide 30 is spring loaded in the upward direction by the carrier (see FIG. 8).

The adjustment slide 30 has guide grooves 31 (see, FIG. 12) on its two sides facing the dividing walls 11 and 12.

The adjustment slide 30 projects, with its upper region, through a guide slot 33 formed in the upper wall 32 of the housing 3, with the result that the side walls of the guide slot 33 project into the guide grooves 31 (see, FIG. 16).

As a result, the adjustment slide 30 is guided such that it can be slid toward the operator side and away from the operator side.

At the same time, said adjustment slide 30 forms a support for the spring arms 29 of the prestressed leaf spring 28.

At an end of coupling 34 facing the operator side, the coupling 34 is coupled by its second end in such a way that it can pivot about a second coupling axis 35, which extends parallel to the door axis 7.

With its first end directed toward the operator side, the coupling 34 is coupled to the closure door 6 in such a way that it can pivot about a first coupling axis 36 which extends parallel to the door axis 7 with radial spacing.

As a result, during an opening process of the closure door 6 a pulling movement is applied toward the operator side, and during a closing process a pushing movement is applied away from the operator side onto the adjustment slide 30 (see FIG. 12).

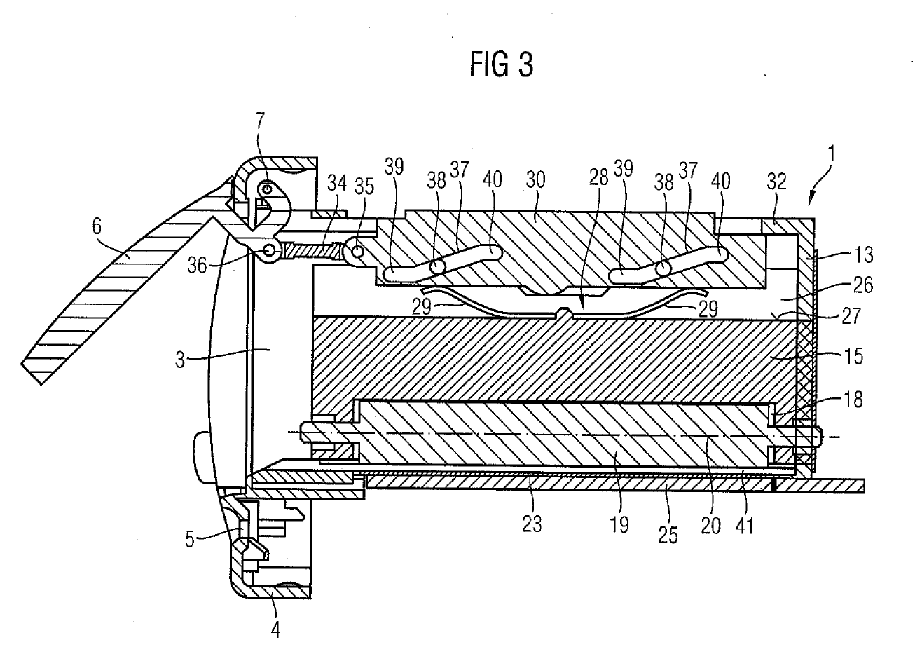

Two link paths 37 are formed at a distance from one another on the adjustment slide 30, which link paths 37 extend in the longitudinal extent of the adjustment slide 30 from an end, which is relatively close to the carrier 15 to an end which is more remote from the carrier 15 (see FIG. 3).

A link block 38 of the carrier 15 engages in each of the link paths 37, parallel to the door axis 7.

Both the ends 39, which are relatively close to the carrier 15, of the link paths 37 and the ends 40, which are more remote from the carrier 15, of the link paths 37 extend in parallel to the roller axis 20.

When the closure door 6 is closed (FIG. 2), the link blocks 38 are located in the link paths 37 at the end 39, which is relatively close to the carrier 15.

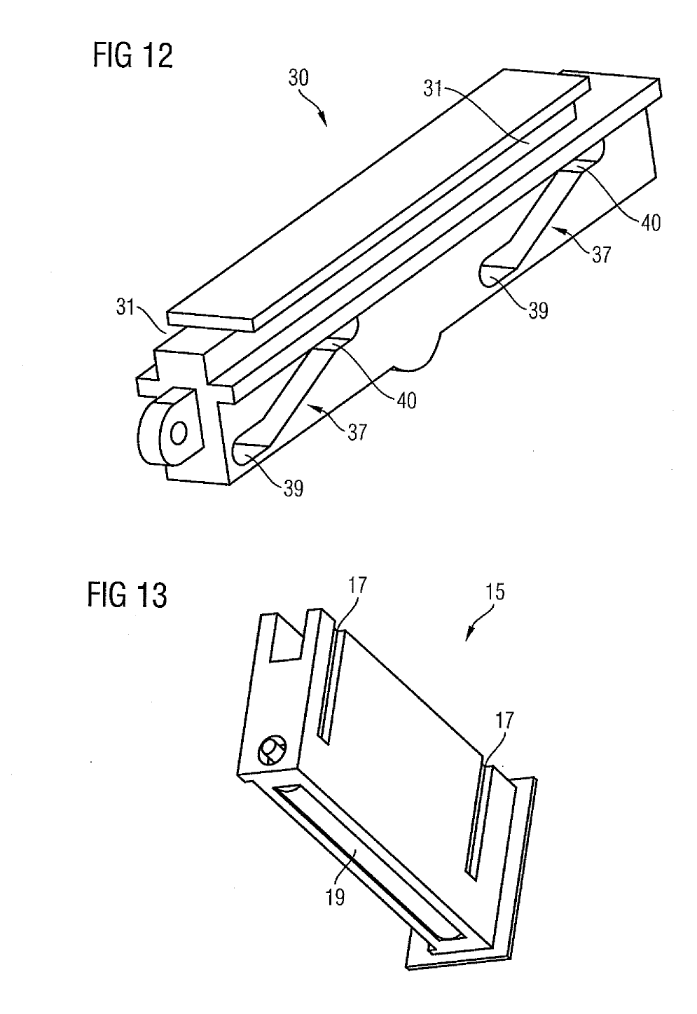

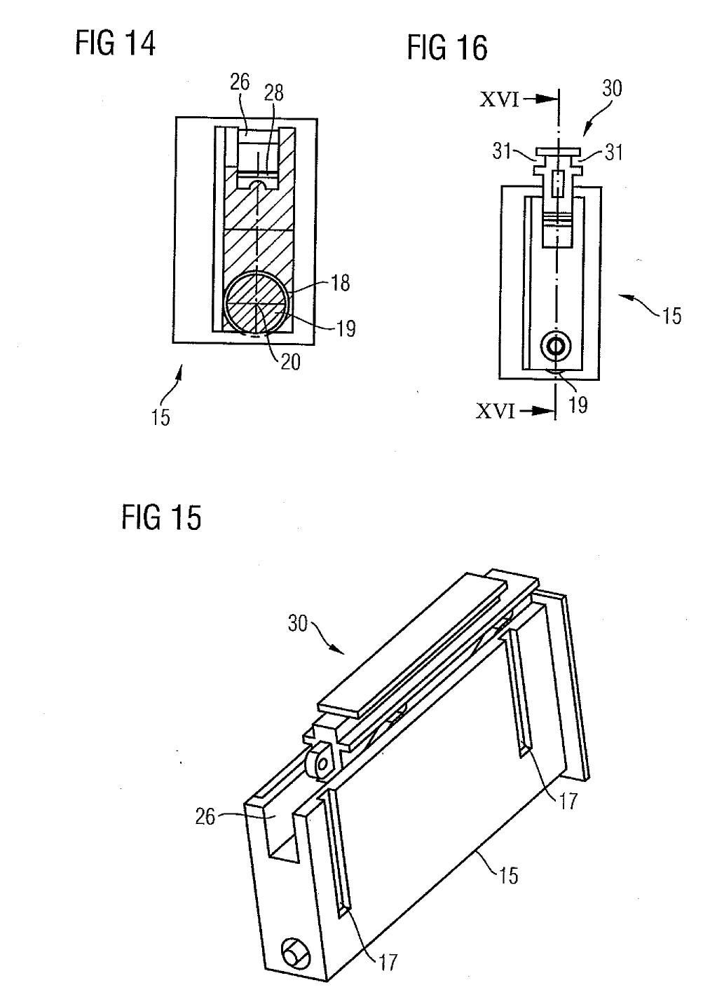

The carrier 15 with the transport roller 19 has assumed here its position in which it is lowered to the greatest extent and in which the transport roller 19 is resting on the thermoprinting strip 24 (see FIGS. 14-16).

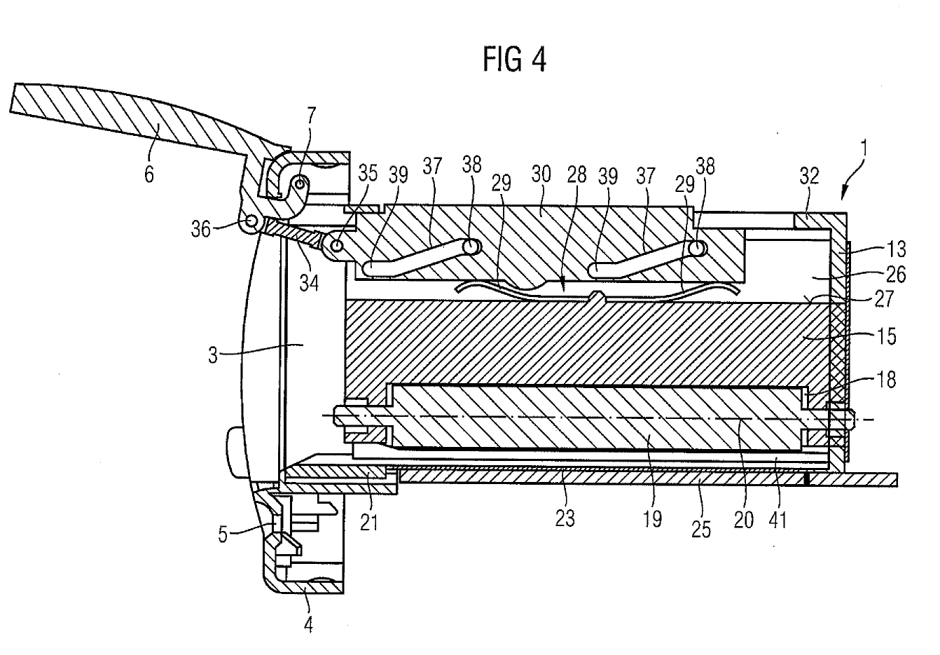

If the closure door 6 is pivoted through its half-open position (FIG. 3) into its completely opened position (FIG. 4), a pulling movement of the adjustment slide 30 toward the operator side occurs.

Since the carrier 15, and with it the link blocks 38, cannot carry out any movement toward or away from the operator side, the link blocks 38 move here from the end 39, relatively close to the carrier 15, of the link paths 37 to the end 39, more remote from the carrier 15, of the link paths 37 (see FIG. 12).

In this context, the carrier 15 is lifted up counter to the force of the leaf spring 28, and the transport roller 19 is lifted off from the thermoprinting strip 24, with the result that a gap 41 is produced between the thermoprinting strip 24 and the transport roller 19 (see FIG. 17).

At the level of this gap 41, there is an approximately horizontally extending feed-in slot 42, which connects the printing material chamber 9 to the printed material chamber 10, in the dividing walls 11 and 12. (See FIG. 6).

If a roll of strip-like printing material is now plugged onto the printing material post 14 when the closure door 6 is opened, the free end region of the strip-like printing material can be pushed transversely into the feed-in slot 42 and the gap 41, with the free end of the strip-like printing material projecting into the printed material chamber 10 (see FIG. 19).

As a result of the closing of the closure door 6, the carrier 15 is also lowered and the transport roller 19 spring loads the printing material against the thermoprinting strip 24.

A drive device as shown schematically in FIG. 2, preferably an electric motor, can now rotatably drive the transport roller 19, if appropriate via a transmission, and as a result feed the printing material for recording data from the printing material chamber 9 to the printed material chamber 10 via the thermoprinting strip 24.

The drive device and transmission are arranged in the carrier 15 here.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-24. (canceled)

25. A trip recorder comprising:
a housing configured as an openable housing comprising an opening directed toward an operator side;
a printing device arranged in the housing, the printing device comprising:
a thermoprinting strip fixedly arranged in the housing; and
a receptacle for a roll of a ribbon-like printing material which can be printed on by the printing device, the roll of ribbon like printing material rotatable about an axis of rotation directed toward the operator side, the receptacle having a region that can be accessed from the operator side; and
a transport roller arranged parallel to and opposite the thermoprinting strip, the transport roller rotatable about an axis directed toward the operator side, the transport roller configured to convey the printing material past the thermoprinting strip, the transport roller further configured to be liftable away from the thermoprinting strip.

26. The trip recorder as claimed in claim 25, wherein the housing comprises a printing material chamber arranged on an insertion side of both the thermoprinting strip and the transport roller.

27. The trip recorder as claimed in claim 26, further comprising a printing material post arranged in the printing material chamber that projects toward the operator side of the housing, the printing material post configured to rotatably accept the roll of the ribbon-like printing material in a freely rotatable fashion.

28. The trip recorder as claimed in claim 25, wherein the housing comprises a printed material chamber on a discharge side of at least one of the thermoprinting strip and the transport roller.

29. The trip recorder as claimed in claim 28, wherein the printed material chamber has a circular cross section into which a feed-in slot opens, the feed-in slot leading from a support region of the transport roller on the thermoprinting strip to the printed material chamber.

30. The trip recorder as claimed in claim 29, wherein the feed-in slot opens substantially tangentially into the printed material chamber.

31. The trip recorder as claimed in claim 25, wherein the opening of the housing is configured to be closed off by a closure.

32. The trip recorder as claimed in claim 31, wherein the closure is a closure door, the closure door being pivotably mounted about a door axis that extends along an edge of the opening.

33. The trip recorder as claimed in claim 25, wherein the transport roller is rotatably mounted on a carrier, the carrier configured to be driven such that it can be moved toward the thermoprinting strip and away from the thermoprinting strip.

34. The trip recorder as claimed in claim 33, wherein the carrier is spring-loaded onto the thermoprinting strip.

35. The trip recorder as claimed in claim 34, wherein the carrier is movably guided by at least one of a guide shaft of the housing and a fixed guide element.

36. The trip recorder as claimed in claim 34, wherein the carrier comprises a drive device for rotatably driving the transport roller.

37. The trip recorder as claimed in claim 34, wherein the carrier is configured to be driven such that the carrier can be moved toward the thermoprinting strip and away from the thermoprinting by a manually activateable adjustment device.

38. The trip recorder as claimed in claim 37, further comprising a closure door configured to close the closure, wherein the adjustment device is coupled to the closure door,
whereby a closing movement of a closure door generates a movement of the carrier toward the thermoprinting strip and an opening movement of the closure door generates a movement of the carrier away from the thermoprinting strip.

39. The trip recorder as claimed in claim 38, wherein an adjustment slide is driveable such that it can be moved in the direction of the operator side guided by at least a part of the housing, the adjustment slide coupled to the closure door by a coupling and coupled to the carrier by a cam drive.

40. The trip recorder as claimed in claim 39, wherein the coupling is coupled by a first end directed toward the operator side with a radial spacing with respect to the door.

41. The trip recorder as claimed in claims 40, wherein the coupling is coupled by a second end to an operator side of the adjustment slide.

42. The trip recorder as claimed in claim 39, wherein the adjustment slide comprises at least one link path that extends in the longitudinal extent of the adjustment slide from an end proximate to the carrier to an end remote from the carrier, the at least one link path configured to engage a link block of the carrier.

43. The trip recorder as claimed in claim 42, wherein a plurality of link paths are arranged one behind the other in the adjustment slide, in the direction of the longitudinal extent of the adjustment slide, wherein each of the plural link paths configured to engage a respective link block of the carrier.

44. The trip recorder as claimed in claim 42, wherein at least one of the end of the link path that is proximate to the carrier and the end of the link path that is remote from the carrier extends parallel to the roller axis.

45. The trip recorder as claimed in claim 39, wherein the adjustment slide is displaceably guided in a guide slot in a wall of the housing.

46. The trip recorder as claimed in claim 45, wherein the adjustment slide comprises guide grooves on sides which are located opposite one another, wherein a web formed between the bases of the guide grooves are insertable into the guide slot.

47. The trip recorder as claimed in claim 25, wherein the thermoprinting strip is arranged on a printed circuit board on which at least part of the system electronics of the trip recorder are mounted.

48. The trip recorder as claimed in claim 47, wherein the thermoprinting strip projects through a cutout in a wall of the housing, and wherein the printed circuit board is arranged on the outside of the wall of the housing.
